(19) United States
(12) Patent Application Publication
(10) Pub. No.: US 2013/0159792 A1
(43) Pub. Date: Jun. 20, 2013

(54) FAULT DETECTION

(71) Applicants: Robert Brooks, Houston, TX (US); Scott Wright, Spring, TX (US); Ted Nguy, Houston, TX (US)

(72) Inventors: Robert Brooks, Houston, TX (US); Scott Wright, Spring, TX (US); Ted Nguy, Houston, TX (US)

(21) Appl. No.: 13/818,494

(22) PCT Filed: Jan. 24, 2011
(86) PCT No.: PCT/US11/22244

§ 371 Date: Feb. 22, 2013

(51) Int. Cl. G06F 1/30

(52) U.S. Cl. CPC G06F 1/30
USPC 714/48

(57) ABSTRACT

Embodiments provide methods, apparatuses, and systems for monitoring and communicating power faults. In various embodiments, a first voltage and a second voltage, both associated with an adapter, are monitored. The first voltage may provide system power and the second voltage may identify a capacity of the adapter. In response to detecting a voltage change, a power failure event may be communicated.

### BACKGROUND

Computing systems are designed to operate in numerous states, for example, low power states. While operating in low power states, computing systems provide power to a limited number of components, thereby saving power. The computing systems, however, retain the ability to quickly and efficiently transition into various other operational states.

When power is removed from computing systems operating, for example, in low power states, residual power within the system may dissipate slowly. The slow dissipation of residual power may enable various components to operate longer than others.

### BRIEF DESCRIPTION OF THE DRAWINGS

FIG. 1 illustrates a block diagram of a system in accordance with various embodiments;

FIG. 2 illustrates a block diagram of an apparatus in accordance with various embodiments;

FIG. 3 illustrates a detection circuit in accordance with various embodiments; and

FIGS. 4-6 illustrate flow diagrams for use in practicing various aspects of the disclosure, in accordance with various embodiments.

### DETAILED DESCRIPTION

Computing systems may utilize low power states to conserve power. The transition between the various states may be controlled by components or devices, such as but not limited to, power management logic. To remain operational throughout the various states, the power management logic may be coupled to and receive power from a low power rail.

When external power is removed from a computing system operating in a low power state, for example by either unplugging a power adapter's direct current (DC) plug from the computing system or by removing the alternating current (AC) plug from an outlet, the residual power within the computing system may dissipate slowly. This slow dissipation of power enables various components to remain operative despite the removal of power. For example, when power is removed from a computing system, the low power rail may continue to supply power to the power management logic while components utilizing other power rails experience power faults. If power is re-introduced, various components may not be properly initialized while the power management logic remains unaware of the power fault. This may prevent proper operation of the computing system.

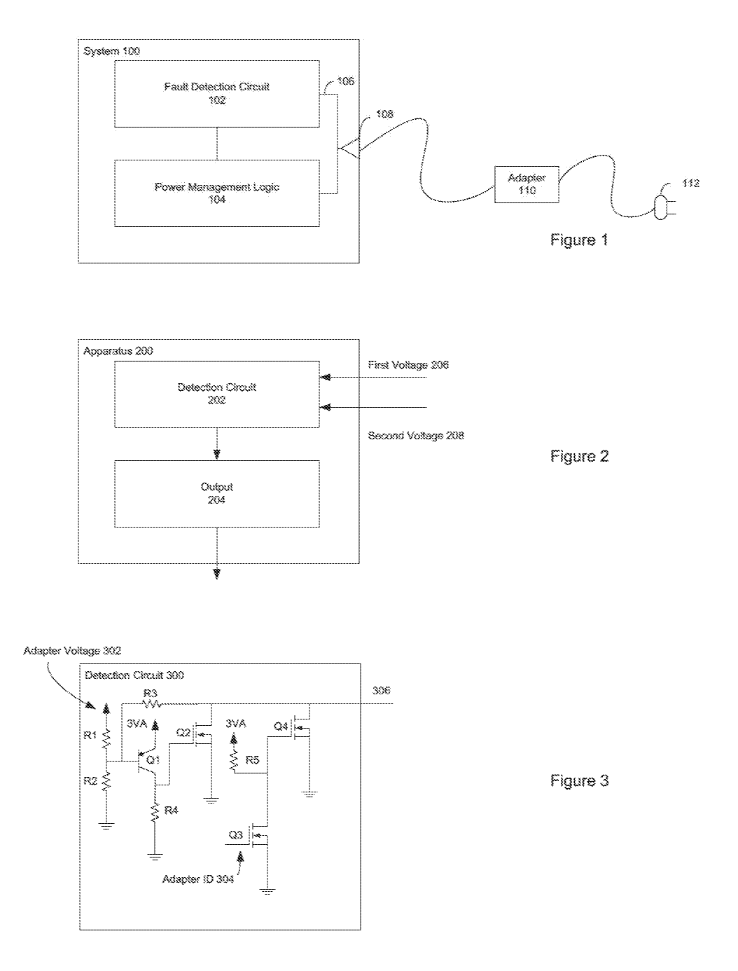

Referring to FIG. 1 a system 100 is illustrated in accordance with various embodiments. The system 100 includes a detection circuit 102, power management logic 104, a power rail 106, and an adapter 110. The adapter 110 may be configured to receive AC power from, for example, a wall outlet via connector 112 and provide power to the system 100 via a connection 108. In addition to providing power to the system 100, the connection 108 may include an adapter identification pin configured to convey a capacity of adapter 110.

Adapters 110 are available in a wide range of output power and voltage combinations, with the larger capacity and higher voltage adapters typically being physically larger and more costly than their low capacity and low voltage brethren. As a consequence, the capacity and output voltage of an adapter is often matched quite closely to its intended load. When a user modifies an electronic device in a manner that affects its power consumption or utilizes an adapter intended for a different system, the adapter may have insufficient capacity or voltage to adequately power the device. The use of an undersized adapter may result in the adapter failing to operate, for example the adapter shutting down to protect itself, or result in damage to the adapter, the electronic device, or both.

To prevent these occurrences, an adapter identification pin may be used. The adapter identification pin, in various embodiments, may include one or more resistors within the adapter. A computing system may couple a voltage source and a known resistor value to the one or more resistors. Measuring the voltage drop across the known resistor may enable the computing system to determine the value of the one or more resistors. The value of the one or more resistors may be used to represent the power rating of the adapter. The identification pin is disclosed more fully in Pat. No. 7,028,202, the disclosure of which is hereby incorporated by reference.

In various embodiments, the adapter 110 can be any device system or combination of systems suitable for adjusting, adapting, or otherwise converting power. In addition, system 100 may be any system such as, but not limited to a notebook computer, a desktop computer, a netbook, or other computing devices.

In various embodiments, the system 100 may incorporate power management logic 104. Power management logic 104 may be configured to control transition of the system 100 between various operating states. The power management logic 104 may be embodied within various controllers, for example, an input/output controller (e.g., the SouthBridge). The power management logic 104 may be configured to receive power from a low power rail 106, such as a three-point-three volt power rail. Receiving power from a low power rail 106 enables the power management logic 104 to maintain operation throughout various operating states of the system 100, including low power states. In various embodiments, the power management logic 104 includes various bits that monitor states of power rails. For example, the power management logic 104 may include a bit configured for assertion in response to a power rail experiencing a fault, i.e., being asserted low. A low assertion on such a bit may indicate power failure. In various embodiments, the bit may serve has a flag to communicate a power failure event. Indication of a power failure may enable the power management logic to transition the computing system into an appropriate state after power has been re-introduced.

In various embodiments, the detection circuit 102 may comprise various components configured to communicate a power failure. The detection circuit 102 may be embodied as an integrated circuit. The detection circuit 102 may be coupled to a low power rail 106, such as three-point-three volt power rail, and may be configured to monitor the adapter voltage and an identification voltage associated with the adapter identification pin.

In various embodiments, the detection circuit 102 may be configured to communicate a power failure to the power management logic 104 prior to the power rail 106 indicating a power failure or experiencing a power fault. For example, in the event that power is removed from system 100, by connector 112 being removed from AC power or connector 108 been removed from system 100, the system power may begin to dissipate. While dissipating, the power management logic 104 may receive residual power. The detection circuit 102 may be configured to communicate a power failure in response to a change in the adapter voltage or in response to a change in an identification voltage associated with the adapter identification pin. By determining a power failure in response to the change in the adapter voltage or the identification voltage, the system 100 may determine that the system power is residual system power and prepare the system to transition to an appropriate state when power is re-applied or when system power is restored.

Referring to FIG. 2, an apparatus 200 is illustrated in accordance with various embodiments. The apparatus 200 is an example of the detection circuit 102 of FIG. 1. The apparatus 200 includes a detection circuit 202 and an output 204. The detection circuit 202 may be configured to monitor a first voltage 206 and a second voltage 208. In various embodiments the first voltage 206 may be an adapter voltage. The adapter voltage may provide system power to the system incorporating apparatus 200. The adapter voltage, in various embodiments, may be approximately nineteen volts. The second voltage may be an identification voltage. The identification voltage may identify a capacity of the adapter supplying the first voltage 206. For example, the second voltage may be a voltage associated with an identification pin of the adapter.

In an embodiment, the output 204 may be configured to indicate a system power failure in response to a change in the first voltage 206, i.e., the adapter voltage. In order to determine that the system power has been removed, the detection circuit 202 may determine whether the first voltage 206 has fallen below a threshold, for example approximately fifteen volts. Other thresholds may be set without deviating from the scope of the disclosure, and the thresholds may vary within a range based upon the characteristics of the components being utilized to implement the detection circuit 202. In one embodiment, the adapter may operate at approximately nineteen volts. The detection circuit 202 may be configured to determine that AC power has been removed in response to the adapter voltage falling below approximately fifteen volts.

In another embodiment, the output 204 is configured to indicate a system power failure in response to a change in the second voltage 208, i.e., the identification voltage. In order to determine that system power has been removed, the detection circuit 202 may monitor the identification pin of the adapter. For example, in one embodiment the presence of a second voltage 208 may indicate an adapter is coupled to a system. Upon a change in the identification voltage, for example, the identification voltage going to zero volts, the detection circuit 202 may determine that the adapter has been removed. Because the adapter's intended capacity does not change, monitoring the identification pin or the identification voltage provides a binary test for whether the adapter is coupled to the system. In response to the identification voltage decreasing or going to zero volts, the output 204 may indicate a power failure. Because the second voltage 208 goes to zero volts before the residual system power has had time to dissipate, the system is able to determine that a power fault has occurred. In various embodiments, the determination may be made despite power being re-introduced before the residual power has fully dissipated.

In response to the detection circuit 202 and output 204 detecting a power failure or fault, the apparatus 200 may signal the power management logic. Signaling the power management logic enables the power management logic to transition the system into an appropriate state when power is re-introduced. In various embodiments, the apparatus 200 may signal the power management logic via a specified bit. The specified bit may be a bit configured to monitor a stage of a power rail, for example, a “DPWROK” bit. The output 204 may assert the bit low, in order to indicate to power management logic that a power fault has occurred. In one embodiment, the apparatus 200 may be coupled to an input/output (I/O) controller SouthBridge) and set a bit within the controller to ground. In other embodiments, the signal may be set high to indicate a power failure.

Referring to FIG. 3, a detection circuit 300 is illustrated in accordance with various embodiments. The detection circuit 300 may be another embodiment of the detection circuit 102 of FIG. 1. The detection circuit 300 may include resistors R1-R5, transistors Q1-Q4, and various inputs and outputs as illustrated. Transistors Q1-Q4 may include bipolar junction transistors (BJTs) or Metal-Oxide Semiconductor Field-Effect Transistor (MOSFETs). The transistors may be N-type transistors or P-type transistors. In one embodiment, R1 is a 100K-Ohm resistors, R2 is a 22K-Ohm resistor, R3 is a 500K-Ohm resistor, R4 is a 10K-Ohm resistor, and R5 is a 100K-Ohm resistor. These values are approximate and it is to be understood that other values are contemplated.

In the illustrated embodiment, the low power rail is identified as a 3VA rail. The 3VA rail provides power to power management logic (not illustrated), which controls the transition of the computing system between various operational states. Detection circuit 300 may enable the power management logic to determine the system has experienced a fault condition despite the 3VA rail remaining powered,

In various embodiments, R1 and R2 may be utilized as a voltage divider. The voltage divider may function to set the voltage threshold below which, the detection circuit 300 may indicate a system power failure. As adapter voltage 302 dissipates, R1 and R2 divide the adapter voltage and turn on Q1, which in the embodiment is a P-type. transistor. As Q1 turns on, the gate of Q2 is coupled to the 3VA rail thus turning Q2 on. With Q2 turned on, the output 306 is tied to a ground voltage, thus indicating a system power failure to power management logic. Because Q1 is turned on prior to the adapter voltage 302 falling to approximately 5 volts, the detection circuit 300 is configured to determine the adapter voltage within the system is residual voltage.

In another embodiment, the detection circuit 300 is configured to determine that adapter identification pin has been removed. As previously described, the adapter identification pin is configured to indentify a capacity of the adapter. Identifying a capacity of the adapter enables appropriate use of the adapter. In the event that the adapter identification pin is removed, the identification voltage, “adapter ID 304,” will be asserted low, e.g., exhibiting approximately zero volts. In this case, Q3, an N-type transistor, will turn off. As Q3 turns off, the gate of Q4 is effectively coupled to the 3VA rail through resistor R5. This turns on transistor Q4 and couples the output 306 to a ground voltage. In this manner, the output of the detection circuit 300 is coupled to a ground voltage when the adapter identification pin is removed from the system. Both removal of the adapter voltage and the adapter identification pin may serve to signal a power fault prior to the residual power substantially dissipating.

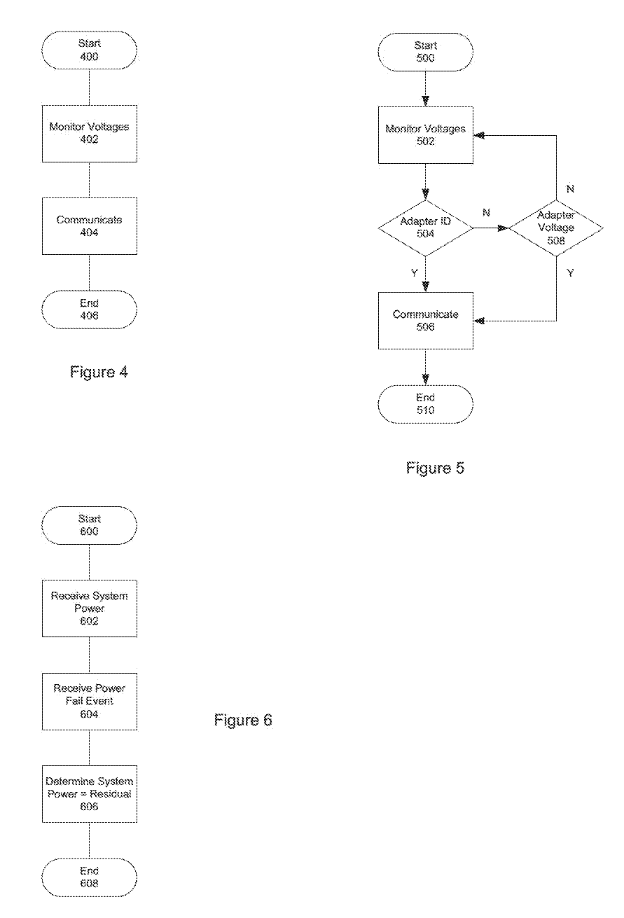

Referring now to FIG. 4, a flow diagram is illustrated in accordance with various embodiments. The method may begin at 400 and progress to 402, where a detection circuit, for example those described with reference to FIGS. 1-3, may monitor a first voltage associated the adapter voltage and a second voltage associated with an identification pin. The first voltage may be utilized provide system power. The second voltage may be utilized to identify a capacity of the adapter. In response to detecting a change in either the first voltage or the second voltage, the method may communicate a power failure event to power management logic at 404.

In response to the power failure event, power management logic may set a specific bit within a controller. The specific bit may be configured to indicate a power failure. In response to the bit, the power management logic may determine that the system power is residual system power, and transition the system into an appropriate state upon the re-application of system power. In one embodiment, the appropriate state may be a booting state in which the system initializes various applications and components.

Referring to FIG. 5, a flow diagram is illustrated in accordance with various embodiments. The method may begin at 500 and progress to 502 where a detection circuit, as illustrated in FIGS. 1-3, monitors a first voltage and a second voltage, wherein the first voltage is utilized to supply system power and the second voltage is utilized to identify a capacity of the adapter.

Progressing to 504, the detection circuit may determine whether the adapter identification pin has been removed from the system. In various embodiments, determining whether the adapter identification pin has been removed may comprise monitoring an identification voltage associated with the adapter. When the identification voltage is substantially equal to zero volts, the system may determine that the adapter identification pin has been removed, and consequently, that system power has been removed. In other embodiments, the system may determine that system power has been removed in response to detecting the second voltage (i.e., the identification voltage) has decreased. Based on either a decrease in the identification voltage or the identification voltage reaching zero volts, the system may communicate a power failure event to power management logic at 506. After communicating the power failure event, the method may end at 510.

Returning to 504, if the detection circuit does not detect a decrease in the adapter identification voltage, the detection circuit may determine whether the first voltage (i.e., the adapter voltage) has decreased at 508. Detecting a decrease in the first voltage may indicate that AC power has been removed and that the system is currently operating on residual power. In various embodiments, detecting a decrease in the first voltage may comprise determining whether the first voltage has fallen below a threshold. If the detection circuit detects a decrease in the adapter voltage at 508, the detection circuit may communicate a power failure event to the power management logic at 506. After communicating the power failure event, the method may end at 510.

Alternatively, if the detection circuit does not detect a decrease the first voltage at 508, the method may continue to monitor voltages at 502. While FIG. 5 discusses the monitoring of the first and second voltages in a sequential order, the disclosure is not so limited. Rather, it is expressly contemplated that the first and second voltages may be monitored in parallel.

Referring to FIG. 6, a flow diagram is illustrated in accordance with various embodiments. In FIG. 6, the method may begin at 600 and progress to 602, where the system receives power. In various embodiments, the system may be in a low power state receiving power from an adapter. The adapter may be coupled to the system and an AC outlet. The adapter may be configured to adapt AC voltages, currents, and power in a suitable manner for the system. At 604, the system may receive a power failure event. In various embodiments, the system may receive a power failure event from a detection circuit, for example a detection circuit as disclosed with reference to FIGS. 1-3, operating in accordance with one of the methods of FIG. 4 or 5. Receipt of a power failure event may comprise the assertion of a specified bit, for example a bit configured to monitor the state of a power rail. In one embodiment, power management logic may be embodied in an I/O controller. The I/O controller may utilize a bit, for example a power-OK (“DPWROK”) bit to indicate that a power rail is valid. In response to a power failure event, the DPWROK pin may be asserted low.

At 606, the system may determine, based on the power failure event, that the system power is residual power and that that upon a re-introduction of system power, the system should transition to a boot state. In various embodiments, the boot state may initialize the system and components.

Although certain embodiments have been illustrated and described herein, it will be appreciated by those of ordinary skill in the art that a wide variety of alternate and/or equivalent embodiments or implementations calculated to achieve the same purposes may be substituted for the embodiments shown and described without departing from the scope of this disclosure. Those with skill in the art will readily appreciate that embodiments may be implemented in a wide variety of ways. This application is intended to cover any adaptations or variations of the embodiments discussed herein. Therefore, it is manifestly intended that embodiments be limited only by the claims and the equivalents thereof.

What is claimed is:

1. An apparatus, comprising:
a detection circuit configured to monitor a first voltage associated with an adapter and a second voltage associated with the adapter, wherein the first voltage provides system power and the second voltage identifies a capacity of the adapter; and
an output coupled to the detection circuit, wherein the output is configured to indicate a power failure in response to the detection circuit detecting a change in the second voltage.

2. The apparatus of claim 1, wherein the output is further configured to indicate the power failure in response to the detection circuit detecting a change in the first voltage.

3. The apparatus of claim 2, wherein the output is further configured to indicate the power failure in response to the detection circuit determining that the first voltage is below a threshold voltage.

4. The apparatus of claim 3, wherein the threshold voltage is approximately fifteen volts.

5. The apparatus of claim 1, wherein the output is further configured to set a flag associated with power management logic to communicate the power failure.

6. A system, comprising:
a power rail configured to distribute power;
power management logic, coupled to the power rail, wherein the power management logic is configured to control a transition of the system between states; and
a detection circuit, coupled to the power management logic, wherein the detection circuit is configured to communicate a power failure to the power management logic based on a change in an identification voltage associated with an adapter, the identification voltage indicating a capacity of the adapter.

7. The system of claim 6, wherein the detection circuit is configured to communicate the power failure to the power management logic prior to the power rail indicating the power failure.

8. The system of claim 6, wherein the detection circuit is further configured to communicate the power failure in response to a change in an adapter voltage, the adapter voltage supplying the power rail with the power.

9. The system of claim 8, wherein the detection circuit is configured to communicate the power failure in response to the adapter voltage falling below a voltage threshold.

10. The system or claim 9, wherein the voltage threshold is approximately fifteen volts.

11. The system or claim 6, wherein the power rail is a three-point-three volt power rail.

12. The system of claim 6, wherein the power management logic comprises a bit configured to indicate the power failure; and
wherein the detection circuit is configured to set the bit to communicate the power failure.

13. A method, comprising:
monitoring, by a detection circuit, a first voltage provided by an adapter and a second voltage associated with an identification pin of the adapter, wherein the first voltage provides system power and the second voltage identifies a capacity of the adapter; and
communicating, by the detection circuit, a power failure event to power management logic in response to detecting a change in either the first voltage or the second voltage.

14. The method or claim 13, wherein said communicating comprises communicating the power failure event in response to detecting a decrease in the second voltage.

15. The method of claim 13, wherein said communicating comprises communicating the power failure event in response to detecting a decrease in the first voltage.

16. The method of claim 15, wherein monitoring the first voltage comprises determining whether the first voltage drops below a voltage threshold.

17. The method of claim 15, wherein monitoring the first voltage comprises determining whether the first voltage drops below fifteen volts.

18. The method of claims 13, wherein said communicating comprises coupling a bit in the power management logic to a ground voltage.

19. The method of claim 13, further comprising:
receiving, by a controller, system power and the power failure event; and
determining, by the controller, the system power is residual system power based on the power failure event.

20. The method of claim 13, further comprising:
transitioning, by the power management logic, system to boot state in response to receipt of the power failure event.
